(19) United States
(12) Patent Application Publication
(10) Pub. No.: US 2016/0055847 A1
(43) Pub. Date: Feb. 25, 2016

(54) SYSTEM AND METHOD FOR SPEECH VALIDATION

(71) Applicant: Nuance Communications, Inc., Burlington, MA (US)

(72) Inventor: Jean E. Dahan, Cote St. Luc (CA)

(21) Appl. No.: 14/463,014

(22) Filed: Aug. 19, 2014

(51) Int. Cl. G10L 15/22; G06F 3/16; G10L 15/08

(52) U.S. Cl. CPC G10L 15/22; G10L 15/08; G06F 3/167; G10L 2015/223; G10L 2015/088

(57) ABSTRACT

A system and method for validating a wake-up-word. Embodiments of the present disclosure may include receiving, at a first computing device, an audio signal from a second computing device, the audio signal being identified as possibly including a wake-up-word. Embodiments may further include rewinding the audio signal to a starting point of the wake-up-word, to generate a rewound audio signal. Embodiments may also include determining if the rewound audio signal includes the wake-up-word. Embodiments may further include transmitting feedback to the second computing device, wherein the feedback includes at least one of a go-back-to-sleep directive and an accepted detection directive.

### TECHNICAL FIELD

This disclosure relates generally to a method for speech recognition, and more particularly, to a method for validating speech such as a wake-up-word, which may be received at a computing device.

### BACKGROUND

Speech recognition, or automatic speech recognition (“ASR”), involves a computerized process that identifies spoken words. There are many uses for speech recognition, including speech transcription, speech translation, ability to control devices and software applications by voice, call routing systems, voice search of the Internet, etc. Speech recognition systems can optionally be paired with spoken language understanding systems to extract meaning and/or commands to execute when interacting with systems.

Speech recognition systems are highly complex and operate by matching an acoustic signature of an utterance with acoustic signatures of words. This matching can optionally be in combination with a statistical language model. Thus, both acoustic modeling and language modeling are used in the speech recognition process. Acoustic models can be created from audio recordings of spoken utterances as well as associated transcriptions. The acoustic model then defines statistical representations of individual sounds for corresponding words. A speech recognition system uses the acoustic model to identify a sequence of sounds, while the speech recognition system uses the statistical language model to identify possible word sequences from the identified sounds.

Speech recognition providing voice-activated or voice command functionality enables speakers to control devices and systems by speaking various instructions. For example, a speaker can utter a command to execute a specific task or utter a query to retrieve specific results. Spoken input can follow a rigid set of phrases that perform specific tasks, or spoken input can be natural language, which is interpreted by a natural language unit of a speech recognition system. Voice command functionality is becoming increasingly popular on portable devices, especially battery-powered portable devices such as cell phones, laptops, and tablet computers. Some devices may include wake-up-word features in which the primary voice control application remains in a “sleep” state until a spoken wake-up command is detected. In some wake-up implementations, the device allows seamless processing of a continuous stream of audio that includes both the wake-up command and an ensuing primary command to the voice control application.

Summary of Disclosure

In one implementation, a method for validating a wake-up-word is provided. Embodiments of the present disclosure may include receiving, at a first computing device, an audio signal from a second computing device, the audio signal being identified as possibly including a wake-up-word. Embodiment may further include rewinding the audio signal to a starting point of the wake-up-word, to generate a rewound audio signal. Embodiments may also include determining if the rewound audio signal includes the wake-up-word. Embodiments may further include transmitting feedback to the second computing device, wherein the feedback includes at least one of a go-back-to-sleep directive and an accepted detection directive.

One or more of the following features may be included. In some embodiments, the starting point may include a pre-determined amount of silence prior to the wake-up-word. The method may include transmitting the determined wake-up-word to the second computing device. The method may further include receiving feedback from the second computing device, wherein the feedback includes at least one of a go-back-to-sleep directive and an accepted detection directive. In some embodiments, feedback may include at least one of an improved pronunciation for the wake-up-word and a threshold setting change recommendation. The method may also include performing a voice biometrics analysis on at least one of the audio signal and the rewound audio signal. The method may further include calculating a confidence score associated with the possible wake-up-word. The method may also include determining whether to transmit the rewound signal, based upon, at least in part, the confidence score.

In another implementation, a method for validating a wake-up-word is provided. Embodiments of the present disclosure may include receiving, at a first computing device, an audio signal from a second computing device, the audio signal being identified as possibly including a wake-up-word. The method may further include rewinding the audio signal to a starting point of the wake-up-word, to generate a rewound audio signal. The method may also include determining if the rewound audio signal includes the wake-up-word. The method may additionally include transmitting feedback to the second computing device, wherein the feedback includes at least one of a go-back-to-sleep directive and an accepted detection directive.

One or more of the following features may be included. In some embodiments, the starting point may include a pre-determined amount of silence prior to the wake-up-word. The method may further include receiving a possible wake-up-word from the first computing device. In some embodiments, feedback may include at least one of an improved pronunciation for the wake-up-word and a threshold setting change recommendation. The method may also include performing a voice biometrics analysis on at least one of the audio signal and the rewound audio signal.

In another implementation, a system is provided. The system may include one or more processors configured to receive, at a first computing device, an audio signal from a second computing device, the audio signal being identified as possibly including a wake-up-word. The one or more processors may be configured to rewind the audio signal to a starting point of the wake-up-word, to generate a rewound audio signal. The one or more processors may be further configured to determine if the rewound audio signal includes the wake-up-word. The one or more processors may be further configured to transmit feedback to the second computing device, wherein the feedback includes at least one of a go-back-to-sleep directive and an accepted detection directive.

One or more of the following features may be included. In some embodiments, the starting point may include a pre-determined amount of silence prior to the wake-up-word. The one or more processors may be configured to receive a possible wake-up-word from the first computing device. Feedback may include at least one of an improved pronunciation for the wake-up-word and a threshold setting change recommendation. The one or more processors may be configured to perform a voice biometrics analysis on at least one of the audio signal and the rewound audio signal.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an example of a speech validation process in accordance with an embodiment of the present disclosure;

FIG. 2 is a flowchart of a speech validation process in accordance with an embodiment of the present disclosure;

FIG. 3 is a flowchart of a speech validation process in accordance with an embodiment of the present disclosure; and

FIG. 4 shows an example of a computer device and a mobile computer device that can be used to implement the speech validation process described herein.

Like reference symbols in the various drawings may indicate like elements.

### DETAILED DESCRIPTION

Embodiments provided herein are directed towards a system and method for validating speech. As used herein, the phrase “wake-up feature” may refer to a situation where a continuous stream of audio may be processed on a device to detect whether a wake-up phrase or wake up word was spoken. Wake-up features are offered in many products such as personal assistants on handsets, in television sets, in cars and/or in instances where a hands-free interface may be needed. One challenge of the feature is that it may run continuously which often implies it must operate on a small CPU/battery/memory budget and without requiring a network connection. After the wake-up is detected, a network connection may be established through which subsequent audio in the same utterance or on a new acquisition may be piped to network ASR servers running the full very large vocabulary for the application (e.g. messaging, web-search, etc.). Additional information regarding speech recognition approaches and wake-up-words may be found in U.S. Publication Number 2013/0289994 having application Ser. No. 13/456,959, available from the Assignee of the present disclosure, a copy of which is hereby incorporated by reference in its entirety.

One issue with this approach is that the small CPU/battery/memory budget generally implies that the best algorithms may not have been used, thereby resulting in many classification errors (e.g., false-detections and false-rejections). Some detection pipelines are staged, with later stages running progressively more complex algorithms, however, the pipeline still generally runs on embedded hardware far less potent than what can be available in a server. As a result the detection algorithm may have high classification error rates.

Accordingly, embodiments included herein suggest applying more sophisticated wake-up phrase detection at the server side in order to reduce the effect of false-detections. The server-side may run more sophisticated acoustic models and may be able to reduce the false-detection rate significantly relative to what an embedded system may be able to achieve.

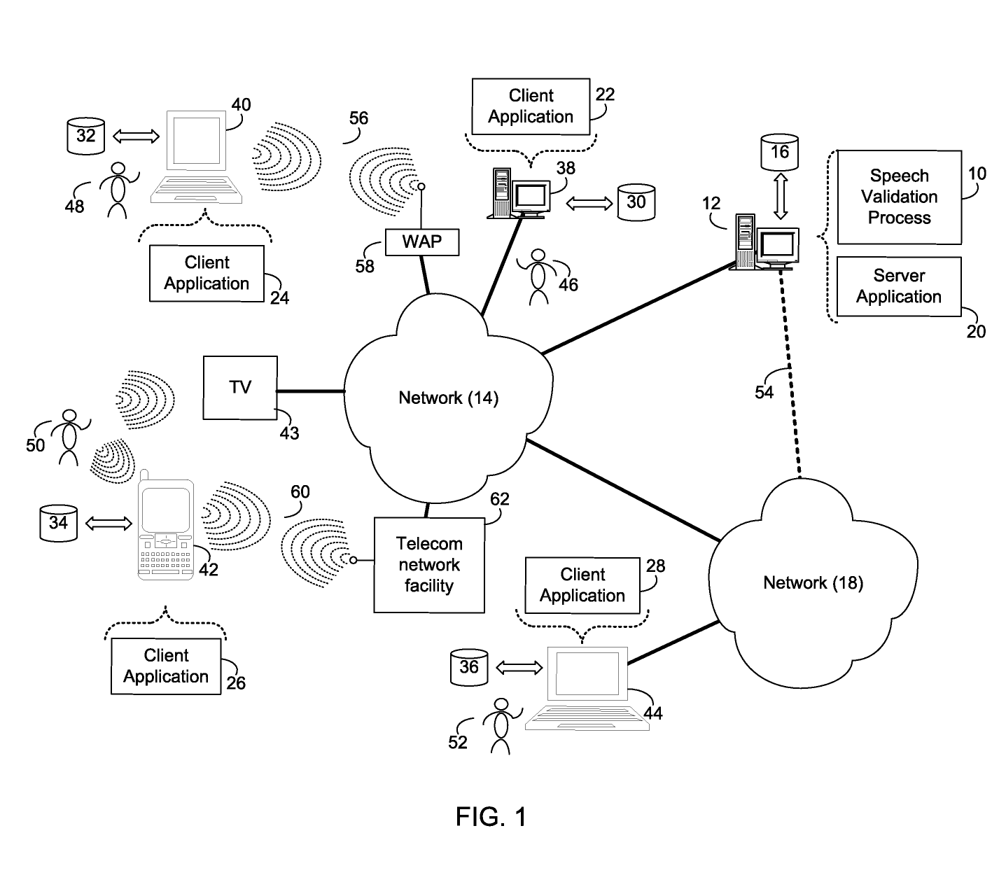

Referring to FIG. 1, there is shown a speech validation process 10 that may reside on and may be executed by computer 12, which may be connected to network 14 (e.g., the Internet or a local area network). Server application 20 may include some or all of the elements of speech validation process 10 described herein. Examples of computer 12 may include but are not limited to a single server computer, a series of server computers, a single personal computer, a series of personal computers, a mini computer, a mainframe computer, an electronic mail server, a social network server, a text message server, a photo server, a multiprocessor computer, one or more virtual machines running on a computing cloud, and/or a distributed system. The various components of computer 12 may execute one or more operating systems, examples of which may include but are not limited to: Microsoft Windows Server ™; Novell Netware ™; Redhat Linux ™, Unix, or a custom operating system, for example.

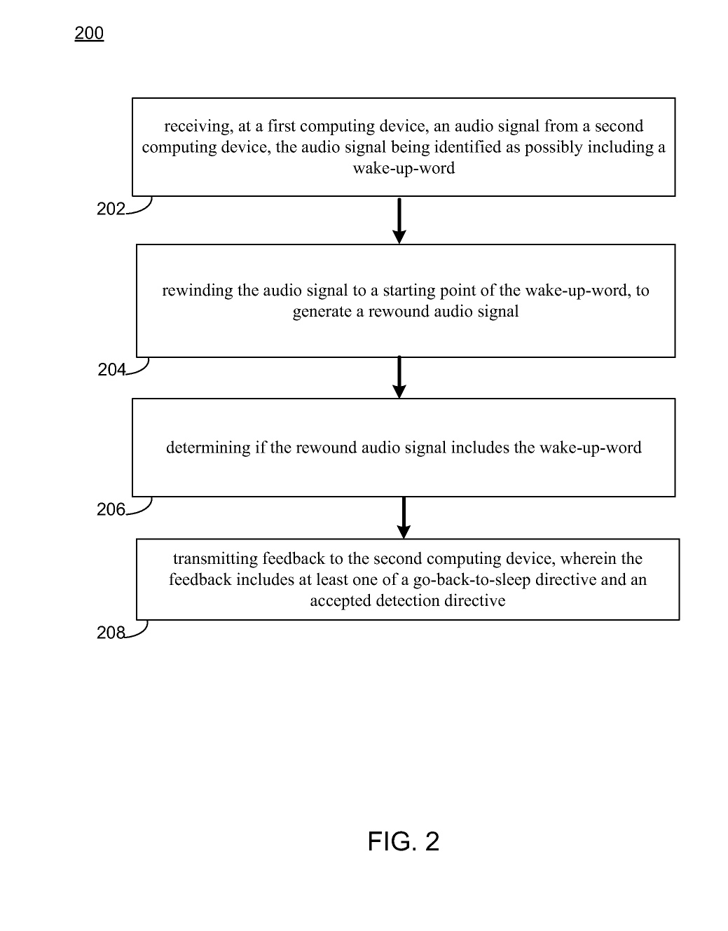

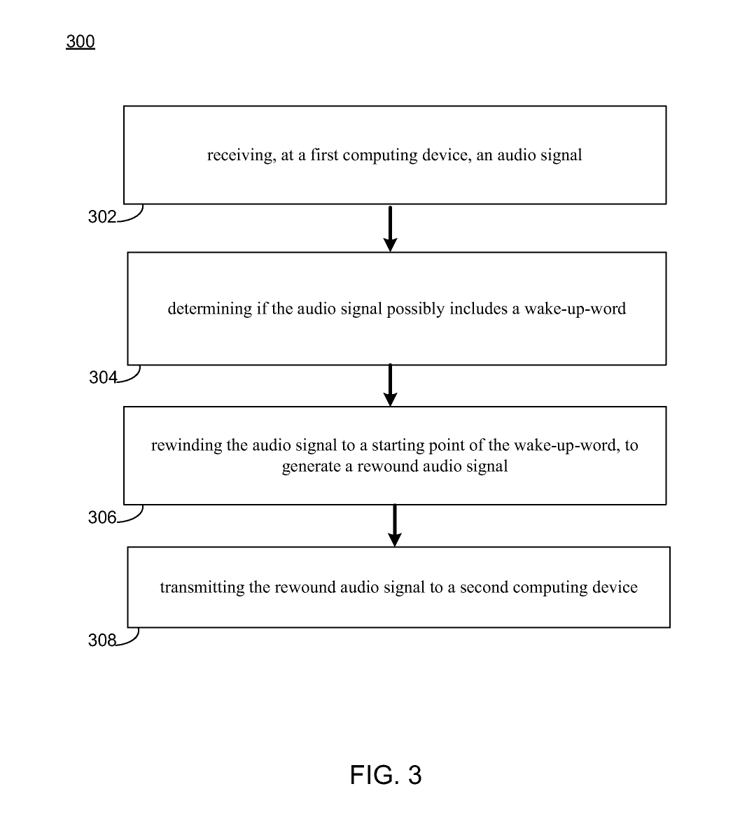

As will be discussed below in greater detail in FIGS. 2-5, speech validation process 10 may include receiving (202), at a first computing device, an audio signal from a second computing device, the audio signal being identified as possibly including a wake-up-word. Embodiments may further include rewinding (204) the audio signal to a starting point of the wake-up-word, to generate a rewound audio signal. Embodiments may also include determining (206) if the rewound audio signal includes the wake-up-word. Embodiments may further include transmitting (208) feedback to the second computing device, wherein the feedback includes at least one of a go-back-to-sleep directive and an accepted detection directive. Numerous other features and configurations are also within the scope of the present disclosure, as is discussed in further detail hereinbelow.

The instruction sets and subroutines of speech validation process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

In some embodiments, speech validation process 10 may be accessed and/or activated via client applications 22, 24, 26, 28. Examples of client applications 22, 24, 26, 28 may include but are not limited to a standard web browser, a customized web browser, or a custom application that can display data to a user. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively).

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, television 43, notebook computer 44, a server (not shown), a data-enabled, cellular telephone (not shown), a dedicated network device (not shown), an audio recording device, etc.

One or more of client applications 22, 24, 26, 28 may be configured to effectuate some or all of the functionality of speech validation process 10. Accordingly, speech validation process 10 may be a purely server-side application, a purely client-side application, or a hybrid server-side/client-side application that is cooperatively executed by one or more of client applications 22, 24, 26, 28 and speech validation process 10.

Client electronic devices 38, 40, 42, 44 may each execute an operating system, examples of which may include but are not limited to Apple iOS ™, Microsoft Windows ™, Android ™, Redhat Linux ™, or a custom operating system. In some cases, the client electronic device may include audio recording functionality and/or may be an audio recording device. Additionally and/or alternatively, in some embodiments an audio recording device may be in communication with one or more of the client electronic devices as is discussed in further detail herein.

Users 46, 48, 50, 52 may access computer 12 and speech validation process 10 directly through network 14 or through secondary network 18. Further, computer 12 may be connected to network 14 through secondary network 18, as illustrated with phantom link line 54. In some embodiments, users may access speech validation process 10 through one or more telecommunications network facilities 62.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and smart phones to be interconnected using a short-range wireless connection.

Smart phone 42 is shown wirelessly coupled to network 14 via wireless communication channel 60 established between smart phone 42 and telecommunications network facility 62, which is shown directly coupled to network 14. In some embodiments, smartphone 42 may be an audio recording device or may include audio recording functionality and may enable an end user to record a speech signal. The speech signal may be stored and/or transmitted to any of the devices described herein. For example, transmitted over network 14 to client electronic device 40.

The phrase “telecommunications network facility”, as used herein, may refer to a facility configured to transmit, and/or receive transmissions to/from one or more mobile devices (e.g. cellphones, etc). In the example shown in FIG. 1, telecommunications network facility 62 may allow for communication between any of the computing devices shown in FIG. 1 (e.g., between cellphone 42 and server computing device 12).

As discussed above, in some embodiments, speech validation process 10 may include receiving an audio signal at a first computing device, for example one of client devices 38, 40, 42, 44 shown in FIG. 1. The audio signal may include a speech signal uttered by a user such as those shown in FIG. 1. Speech validation process 10 may include determining if the audio signal possibly includes a wake-up-word. For example, one of client devices 38, 40, 42, 44 may determine that a wake-up-word has possibly been uttered and then may rewind the audio signal to a starting point of the wake-up-word, to generate a rewound audio signal. In this particular example, rewinding may occur on the client device, however, rewinding may occur on any suitable device, for example on server computing device 12 shown in FIG. 1. In some embodiments, speech validation process 10 may include transmitting the rewound audio signal from the client device to a second computing device, for example server computing device 12.

In some embodiments, rewinding may include rewinding the audio signal to any point in time associated with a particular signal. For example, in some cases this may include rewinding to the starting point of the wake-up-word, which may include rewinding to include some pre-determined amount of silence just prior to the utterance of the wake-up-word.

In some embodiments, speech validation process 10 may include transmitting the determined wake-up-word to the second computing device. For example, client device 42 may be configured to transmit the suspected wake-up-word to server computing device 12. Once server computing device has performed the necessary processing on the received audio signal, client device 42 may be configured to receive feedback from the second computing device (e.g., server computing device 12). The feedback may include a go-back-to-sleep directive and/or an accepted detection directive depending upon the determination made at the second computing device. In some examples, the feedback may include an improved pronunciation for the wake-up-word, a threshold setting change recommendation or any other suitable feedback.

In some embodiments, speech validation process 10 may include performing a voice biometrics analysis on at least one of the audio signal and the rewound audio signal. This may occur at any suitable device such as client device 42, server computing device 12, hybrid combinations, etc.

In some embodiments, speech validation process 10 may include calculating a confidence score associated with the possible wake-up-word. For example, client device 42 may perform an analysis on the audio signal to determine how likely it is that the wake-up-word was spoken. If the confidence score is above a certain predefined threshold value, speech validation process 10 may determine whether to transmit the rewound signal, based upon, at least in part, the confidence score.

As discussed above, certain operations associated with speech validation process 10 may be performed via client devices, server devices or combinations thereof. For example, in some embodiments, speech validation process 10 may include receiving, at a first computing device (e.g. server computing device 12), an audio signal from a second computing device (e.g. client device 42), the audio signal being identified as possibly including a wake-up-word. In this particular example, speech validation process 10 may include rewinding, at server computing device 12, the audio signal to a starting point of the wake-up-word, to generate a rewound audio signal. Speech validation process 10 may include determining, at server computing device 12, if the rewound audio signal includes the wake-up-word. Server computing device 12 may then transmit feedback to the second computing device(e.g. client device 42), wherein the feedback includes at least one of a go-back-to-sleep directive and an accepted detection directive, and/or information to tune the wake-up detection at the first computing device.

Embodiments of speech validation process 10 may work in conjunction with a wake-up feature where a continuous stream of audio is processed on an embedded device to detect whether a wake-up phrase was spoken. Dialog/ASR systems that run on the network are generally invoked only after a wake-up is detected at the device, but the wake-up detection is inherently a statistical process which can make errors. When those false-detections reach the server it may lead to runaway dialogs, where the system wakes up and starts interacting with a user who does not want to engage the system at this time, or with no real user at all if the wake-up was falsely triggered (e.g., from a background radio, etc.). The dialog systems generally do not require further tactile input from the user, so runaway dialogs could follow with unintended consequences. After the wake-up phrases are detected, a command from the user generally ensues and it was commonplace for the embedded system to perform audio surgery on acoustic signal to strip out the detected wake-up phrase leaving only the command to be processed by the server. This was found to be suboptimal for a number of reasons. For example, the audio surgery removes important acoustic context from the audio stream that the server needs for acoustic normalization. The audio surgery could be defective due to the segmentation driven by small acoustic models. It is also possible the wake-up phrase was not spoken at all.

Accordingly, embodiments of speech validation process 10 may allow the acquisition system to perform buffering so that the application is able to rewind the audio stream to the point where the wake-up phrase started, and possibly include some silence before. In a network ASR request, the application may pass the identity of the wake-up phrase detected along with the full (e.g., rewound) audio stream. The network engine may be configured to re-qualify whether that wake-up phrase was indeed there, and may also issue a “go-back-to-sleep” directive to the device if it finds the wake-up phrase was not there. The server-side detection may also be an inherently statistic system and it can introduce errors, but with much larger acoustic and language models, the server-side generally has much lower classification error rates. The server-side may then be viewed as a final stage in the wake-up detection process. With that, the rejection thresholds at the earlier stages may be relaxed to improve the recall in the early stages, leaving precision for the later stages.

In some embodiments, the server may provide feedback to the embedded ASR wake-up system along with the “go-back-to-sleep” or accepted detection directives. For example, the server may be configured to pass back improved pronunciations for the wake-up words, or possibly pass back threshold setting change recommendations.

In some embodiments, speech validation process 10 may include server-side re-questioning of a wake-up decision of an embedded ASR. In some embodiments, the wake-up may be performed on an embedded device which may also involve audio surgery, removing the wake-up phrase or word from the audio before streaming to the server.

In some embodiments, the first computing device may be configured to begin streaming the audio to the second computing device starting from the point after the wake-up command. Speech validation process 10 may further include the first computing device rewinding the audio signal to a starting point of the wake-up-word, to generate a rewound audio signal. Embodiments may also include the second device determining or re-determining if the rewound audio signal includes the wake-up-word.

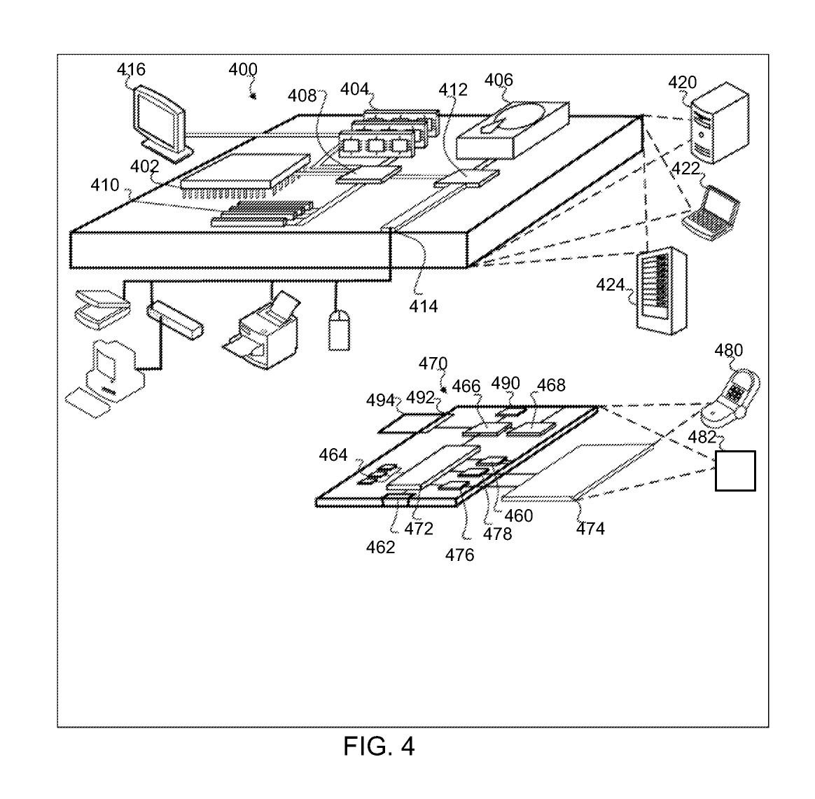

Referring now to FIG. 4, an example of a generic computer device 400 and a generic mobile computer device 470, which may be used with the techniques described here is provided. Computing device 400 is intended to represent various forms of digital computers, such as tablet computers, laptops, desktops, workstations, personal digital assistants, servers, blade servers, mainframes, and other appropriate computers. In some embodiments, computing device 470 can include various forms of mobile devices, such as personal digital assistants, cellular telephones, smartphones, and other similar computing devices. Computing device 470 and/or computing device 400 may also include other devices, such as televisions with one or more processors embedded therein or attached thereto. The components shown here, their connections and relationships, and their functions, are meant to be exemplary only, and are not meant to limit implementations of the inventions described and/or claimed in this document.

In some embodiments, computing device 400 may include processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, may be interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

Memory 404 may store information within the computing device 400. In one implementation, the memory 404 may be a volatile memory unit or units. In another implementation, the memory 404 may be a non-volatile memory unit or units. The memory 404 may also be another form of computer-readable medium, such as a magnetic or optical disk.

Storage device 406 may be capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, memory on processor 402, or a propagated signal.

High speed controller 408 may manage bandwidth-intensive operations for the computing device 400, while the low speed controller 412 may manage lower bandwidth-intensive operations. Such allocation of functions is exemplary only. In one implementation, the high-speed controller 408 may be coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 470. Each of such devices may contain one or more of computing device 400, 470, and an entire system may be made up of multiple computing devices 400, 470 communicating with each other.

Computing device 470 may include a processor 472, memory 464, an input/output device such as a display 474, a communication interface 466, and a transceiver 468, among other components. The device 470 may also be provided with a storage device, such as a microdrive or other device, to provide additional storage. Each of the components 470, 472, 464, 474, 466, and 468, may be interconnected using various buses, and several of the components may be mounted on a common motherboard or in other manners as appropriate.

Processor 472 may execute instructions within the computing device 470, including instructions stored in the memory 464. The processor may be implemented as a chipset of chips that include separate and multiple analog and digital processors. The processor may provide, for example, for coordination of the other components of the device 470, such as control of user interfaces, applications run by device 470, and wireless communication by device 470.

In some embodiments, processor 472 may communicate with a user through control interface 478 and display interface 476 coupled to a display 474. The display 474 may be, for example, a TFT LCD (Thin-Film-Transistor Liquid Crystal Display) or an OLED (Organic Light Emitting Diode) display, or other appropriate display technology. The display interface 476 may comprise appropriate circuitry for driving the display 474 to present graphical and other information to a user. The control interface 478 may receive commands from a user and convert them for submission to the processor 472. In addition, an external interface 462 may be provide in communication with processor 472, so as to enable near area communication of device 470 with other devices. External interface 462 may provide, for example, for wired communication in some implementations, or for wireless communication in other implementations, and multiple interfaces may also be used.

In some embodiments, memory 464 may store information within the computing device 470. The memory 464 can be implemented as one or more of a computer-readable medium or media, a volatile memory unit or units, or a non-volatile memory unit or units. Expansion memory 474 may also be provided and connected to device 470 through expansion interface 472, which may include, for example, a SIMM (Single In Line Memory Module) card interface. Such expansion memory 474 may provide extra storage space for device 470, or may also store applications or other information for device 470. Specifically, expansion memory 474 may include instructions to carry out or supplement the processes described above, and may include secure information also. Thus, for example, expansion memory 474 may be provide as a security module for device 470, and may be programmed with instructions that permit secure use of device 470. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 464, expansion memory 474, memory on processor 472, or a propagated signal that may be received, for example, over transceiver 468 or external interface 462.

Device 470 may communicate wirelessly through communication interface 466, which may include digital signal processing circuitry where necessary. Communication interface 466 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 470, which may be used as appropriate by applications running on device 470.

Device 470 may also communicate audibly using audio codec 460, which may receive spoken information from a user and convert it to usable digital information. Audio codec 460 may likewise generate audible sound for a user, such as through a speaker, e.g., in a handset of device 470. Such sound may include sound from voice telephone calls, may include recorded sound (e.g., voice messages, music files, etc.) and may also include sound generated by applications operating on device 470.

Computing device 470 may be implemented in a number of different forms, as shown in the figure. For example, it may be implemented as a cellular telephone 480. It may also be implemented as part of a smartphone 482, personal digital assistant, remote control, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized (e.g. non-transitory mediums). The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving, at a first computing device, an audio signal;
determining if the audio signal possibly includes a wake-up-word;
rewinding the audio signal to a starting point of the wake-up-word, to generate a rewound audio signal; and
transmitting the rewound audio signal to a second computing device.

2. The method of claim 1, wherein the starting point includes a pre-determined amount of silence prior to the wake-up-word.

3. The method of claim 1, further comprising:
transmitting the determined wake-up-word to the second computing device.

4. The method of claim 1, further comprising:
receiving feedback from the second computing device, wherein the feedback includes at least one of a go-back-to-sleep directive and an accepted detection directive.

5. The method of claim 4, wherein feedback includes at least one of an improved pronunciation for the wake-up-word and a threshold setting change recommendation.

6. The method of claim 1, further comprising:
performing a voice biometrics analysis on at least one of the audio signal and the rewound audio signal.

7. The method of claim 1, further comprising:
calculating a confidence score associated with the possible wake-up-word.

8. The method of claim 7, further comprising:
determining whether to transmit the rewound signal, based upon, at least in part, the confidence score.

9. A computer-implemented method comprising:
receiving, at a first computing device, an audio signal from a second computing device, the audio signal being identified as possibly including a wake-up-word;
rewinding the audio signal to a starting point of the wake-up-word, to generate a rewound audio signal;
determining if the rewound audio signal includes the wake-up-word; and
transmitting feedback to the second computing device, wherein the feedback includes at least one of a go-back-to-sleep directive and an accepted detection directive.

10. The method of claim 9, wherein the starting point includes a pre-determined amount of silence prior to the wake-up-word.

11. The method of claim 9, further comprising:
receiving a possible wake-up-word from the first computing device.

12. The method of claim 9, wherein feedback includes at least one of an improved pronunciation for the wake-up-word and a threshold setting change recommendation.

13. The method of claim 9, further comprising:
performing a voice biometrics analysis on at least one of the audio signal and the rewound audio signal.

14. A system comprising:
one or more processors configured to receive, at a first computing device, an audio signal from a second computing device, the audio signal being identified as possibly including a wake-up-word, the one or more processors configured to rewind the audio signal to a starting point of the wake-up-word, to generate a rewound audio signal, the one or more processors further configured to determine if the rewound audio signal includes the wake-up-word, the one or more processors further configured to transmit feedback to the second computing device, wherein the feedback includes at least one of a go-back-to-sleep directive and an accepted detection directive.

15. The system of claim 14, wherein the starting point includes a pre-determined amount of silence prior to the wake-up-word.

16. The system of claim 14, wherein the one or more processors are configured to receive a possible wake-up-word from the first computing device.

17. The system of claim 14, wherein feedback includes at least one of an improved pronunciation for the wake-up-word and a threshold setting change recommendation.

18. The system of claim 14, wherein the one or more processors are configured to perform a voice biometrics analysis on at least one of the audio signal and the rewound audio signal.
